(19) United States
(12) Patent Application Publication
(10) Pub. No.: US 2009/0158668 A1
(43) Pub. Date: Jun. 25, 2009

(54) Side door of vehicle

(75) Inventors: Toshihito Nonaka, Chiryu-City (JP); Minoru Fujioka, Anjo-city (JP); Shingo Wanami, Kariya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/316,726

(22) Filed: Dec. 16, 2008

(30) Foreign Application Priority Data
Dec. 25, 2007 (JP) 2007-332817

(51) Int. Cl. B60J 5/04; E05D 11/00

(52) U.S. Cl. 49/502; 16/223

(57) ABSTRACT

A side door of a vehicle includes an outer panel, an inner panel, a reinforcing member, a front attaching part, a rear attaching part, and an acceleration sensor. The reinforcing member is located between the outer panel and the inner panel. The front attaching part and a rear attaching part are coupled with the reinforcing member. The front attaching part is fixed to a front attached portion provided at one of a front end portion of the outer panel and a front end portion of the inner panel. The rear attaching part is fixed to a rear attached portion provided at one of a rear end portion of the outer panel and a rear end portion of the inner panel. The acceleration sensor is disposed at one of the end portions.

### CROSS REFERENCE TO RELATED APPLICATIONS

The present application is based on and claims priority to Japanese Patent Application No. 2007-332817 filed on Dec. 25, 2007, the contents of which are incorporated in their entirety herein by reference.

### BACKGROUND OF THE INVENTION

1. Field of the Invention

The present invention relates to a side door of a vehicle.

2. Description of the Related Art

JP-A-9-315262 discloses a method of equipping a vehicle with an acceleration sensor for detecting a collision on a side of the vehicle. In the method, the acceleration sensor is disposed in a B-pillar, i.e., a center pillar of the vehicle. When an object collides on the side of the vehicle, a side airbag and/or a curtain airbag deploy based on acceleration data detected by the acceleration sensor.

In a case where the object that collides on the side of the vehicle is wide, for example, like a vehicle, the object collides with the center pillar with a high probability. However, in a case where the object collides with a side door at an angle or in a case where the object is narrow, for example, like a telegraph pole, the object may not collide with the center pillar. In the present case, an acceleration pathway is long. Thus, impact acceleration is reduced and a transmission time of the impact acceleration increases.

Alternatively, an acceleration sensor may be disposed in a side door. For example, the acceleration sensor may be disposed at one of an outer panel, an inner panel, and a reinforcing member of the side door.

In a case where the acceleration sensor is disposed at the outer panel, a control device of the airbag may determine that there is a collision even when the side door is opened and collides with a telegraph pole, a guardrail, or a wall. In a case where an acceleration sensor 40 is disposed at a center portion of an inner panel 401 of a side door 400, as illustrated in FIG. 11A and FIG. 11B, when an outer panel 402 of the side door 400 collides with a telegraph pole 500, impact acceleration is transmitted to the acceleration sensor 40 through a reinforcing member 403 as shown by arrows XI. Thus, an acceleration pathway from a collided portion to the acceleration sensor 40 is long, the impact acceleration is reduced, and a transmission time of the impact acceleration increases. In a case where the acceleration sensor is disposed at the reinforcing member, the acceleration sensor may receive a direct hit of the object. Thus, the acceleration sensor may be broken before outputting acceleration data, and the airbag may not deploy despite a collision from which an occupant needs protection.

### SUMMARY OF THE INVENTION

In view of the foregoing problems, it is an object of the present invention to provide a side door of a vehicle.

A side door of a vehicle according to an aspect of the present invention includes an outer panel, an inner panel, a reinforcing member, a front attaching part, a rear attaching part, and an acceleration sensor. The outer panel has a front end portion, a center portion, and a rear end portion in a front-rear direction of the vehicle. The inner panel is located opposite to the outer panel and has a front end portion, a center portion, and a rear end portion in the front-rear direction. The reinforcing member is located between the outer panel and the inner panel. The front attaching part and the rear attaching part are coupled with the reinforcing member. The front attaching part is fixed to a front attached portion provided at one of the front end portion of the outer panel and the front end portion of the inner panel. The rear attaching part is fixed to a rear attached portion provided at one of the rear end portion of the outer panel and the rear end portion of the inner panel. The acceleration sensor is disposed at one of the front end portion of the outer panel, the front end portion of the inner panel, the rear end portion of the outer panel, and the rear end portion of the inner panel, for detecting an impact acceleration applied to the reinforcing member when an object collides with the side door. A flexural rigidity of the front end portion of the outer panel and a flexural rigidity of the rear end portion of the outer panel are greater than a flexural rigidity of the center portion of the outer panel. A flexural rigidity of the front end portion of the inner panel and a flexural rigidity of the rear end portion of the inner panel are greater than a flexural rigidity of the center portion of the inner panel. A flexural rigidity of the reinforcing member, a flexural rigidity of the front attaching part, and a flexural rigidity of the rear attaching part are greater than the flexural rigidity of the center portion of the outer panel. In the present side door, the acceleration sensor can detect the impact acceleration early with a high degree of certainty.

### BRIEF DESCRIPTION OF THE DRAWINGS

Additional objects and advantages of the present invention will be more readily apparent from the following detailed description of preferred embodiments when taken together with the accompanying drawings. In the drawings

FIG. 1 is a perspective view illustrating a side door of a vehicle according to a first embodiment;

FIG. 2 is a cross-sectional view illustrating the side door taken along line II-II in FIG. 1;

FIG. 3A is a cross-sectional view illustrating the side door taken along line IIIA-IIIA in FIG. 2 and FIG. 3B is a cross-sectional view illustrating the side door taken along line IIIB-IIIB in FIG. 3A;

FIG. 4 is a cross-sectional view illustrating an acceleration pathway in the side door illustrated in FIG. 2;

FIG. 5 is a graph illustrating a relationship between a detected acceleration and a detecting time;

FIG. 6 is a diagram illustrating exemplary positions where an acceleration sensor is attached;

FIG. 7 is a cross-sectional view illustrating a side door according to a modification of the first embodiment;

FIG. 8A is a cross-sectional view illustrating a side door according to a second embodiment and FIG. 8B is a cross-sectional view illustrating a side door according to a modification of the second embodiment;

FIG. 9 is a cross-sectional view illustrating a side door according to a third embodiment;

FIG. 10 is a diagram illustrating an effect of the side door illustrated in FIG. 9; and

FIG. 11A is a perspective view illustrating a side door according to an example of the related art and FIG. 11B is a diagram illustrating an acceleration pathway in the semiconductor device illustrated in FIG. 11A.

### DETAILED DESCRIPTION OF THE PREFERRED EMBODIMENTS

### First Embodiment

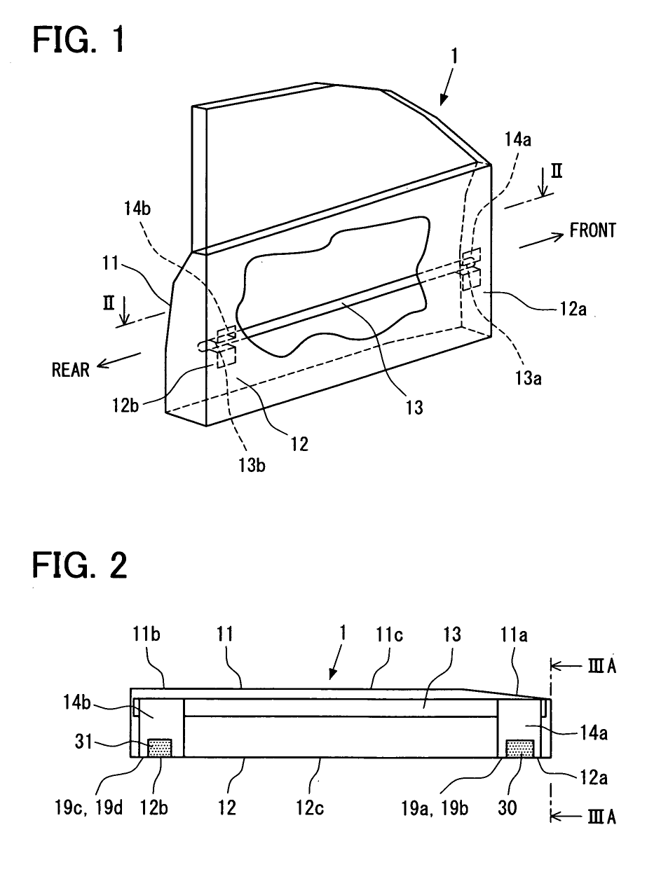

A side door 1 of a vehicle according to a first embodiment will be described with reference to FIG.1-FIG.6. In FIG.1, the side door 1 viewed from an inside of the vehicle is illustrated. The side door 1 includes an outer panel 11 located on an outside of the vehicle and an inner panel 12 located on an inside of the vehicle. The outer panel 11 and the inner panel 12 are opposite to each other so as to have a distance therebetween. The outer panel 11 has a front end portion 11a, a rear end portion 11b, and a center portion 11c in a front-rear direction of the vehicle. The inner panel 12 has a front end portion 12a, a rear end portion 12b, and a center portion 12c in the front-rear direction of the vehicle. In FIG. 1, a part of the center portion 12c of the inner panel 12 is cutout for a purpose of a description. The end portions 11a, 11b, 12a, and 12b are treated with a drawing process so that the outer panel 11 and the inner panel 12 are connected with each other and each of the connected end portions has an approximately U-shape in a horizontal cross section, as illustrated in FIG. 2. Thus, a flexural rigidity of the end portions 11a, 11b, 12a, and 12b is greater than a flexural rigidity of the center portions 11c and 12c each having an approximately flat shape.

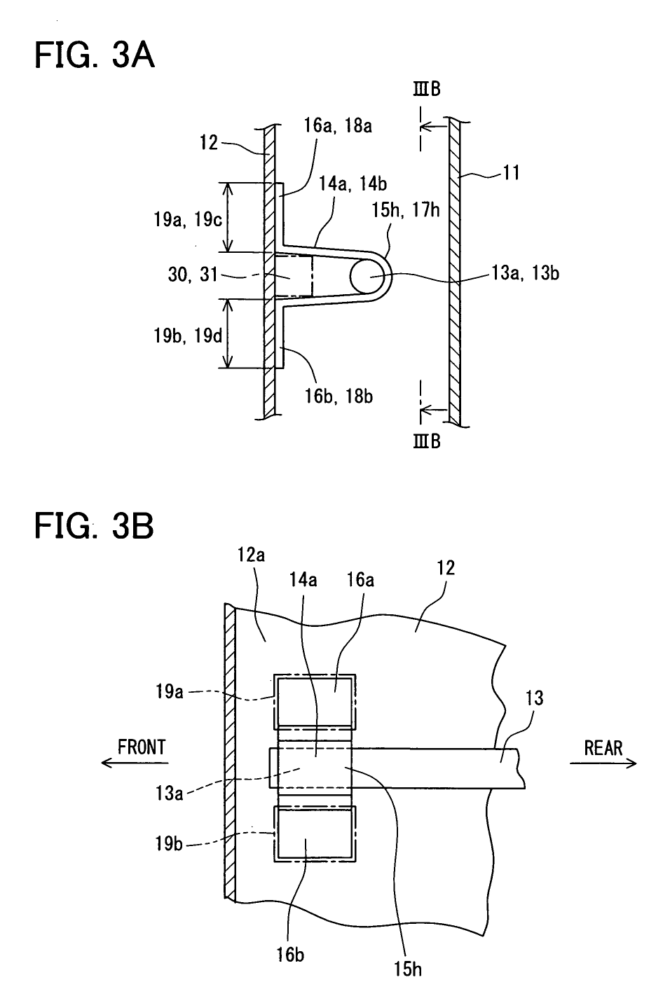

Between the outer panel 11 and the inner panel 12, a reinforcing member 13 extends in the front-rear direction of the vehicle. The reinforcing member 13 has an approximately cylindrical shape, for example. The reinforcing member 13 has a front end portion 13a and a rear end portion 13b. As illustrated in FIG. 3A, the front end portion 13a is fixed to a curved portion 15h of a front attaching part 14a and the rear end portion 13b is fixed to a curved portion 17h of a rear attaching part 14b.

The front attaching part 14a has an upper flange 16a and a lower flange 16b. The front end portion 12a of the inner panel 12 has an upper attached portion 19a and a lower attached portion 19b. The upper flange 16a is fixed to the upper attached portion 19a and the lower flange 16b is fixed to the lower attached portion 19b. The rear attaching part 14b has an upper flange 18a and a lower flange 18b. The rear end portion 12b of the inner panel 12 has an upper attached portion 19c and a lower attached portion 19d. The upper flange 18a is fixed to the upper attached portion 19c and the lower flange 18b is fixed to the lower attached portion 19d. Thereby, the reinforcing member 13 is attached to the side door 1 through the attaching parts 14a and 14b. A flexural rigidity of the reinforcing member 13 is larger than the flexural rigidity of the center portion of the outer panel 11. In addition, a flexural rigidity of the attaching parts 14a and 14b firmly fixed to the reinforcing member 13 is also greater than the flexural rigidity of the center portion of the outer panel 11. The flexural rigidity of the attaching parts 14a and 14b may be substantially equal to the flexural rigidity of the reinforcing member 13.

The front end portion 12a is defined as a portion of the inner panel 12 from a front end to a predetermined distance and including the upper attached portion 19a and the lower attached portion 19b. The rear end portion 12b is defined as a portion of the inner panel 12 from a rear end to a predetermined distance and including the upper attached portion 19c and the lower attached portion 19d. The front end portion 11a is defined as a portion of the outer panel 11 from a front end to a predetermined distance and including portions facing the upper attached portion 19a and the lower attached portion 19b. The rear end portion 11b is defined as a portion of the outer panel 11 from a rear end to a predetermined distance and including portions facing the upper attached portion 19c and the lower attached portion 19d. As described above, the end portions 11a, 11b, 12a, and 12b are treated with the drawing process. Thus, each of the end portions 11a, 11b, 12a, and 12b has a high flexural rigidity.

As illustrated in FIG. 2 and FIG. 3A, a front acceleration sensor 30 and a rear front acceleration sensor 31 are disposed on a surface of the inner panel 12 on the outer panel 11 side. For example, the front acceleration sensor 30 is disposed between the upper attached portion 19a and the lower attached portion 19b of the front end portion 12a and the rear acceleration sensor 31 is disposed between the upper attached portion 19c and the lower attached portion 19d of the rear end portion 12b.

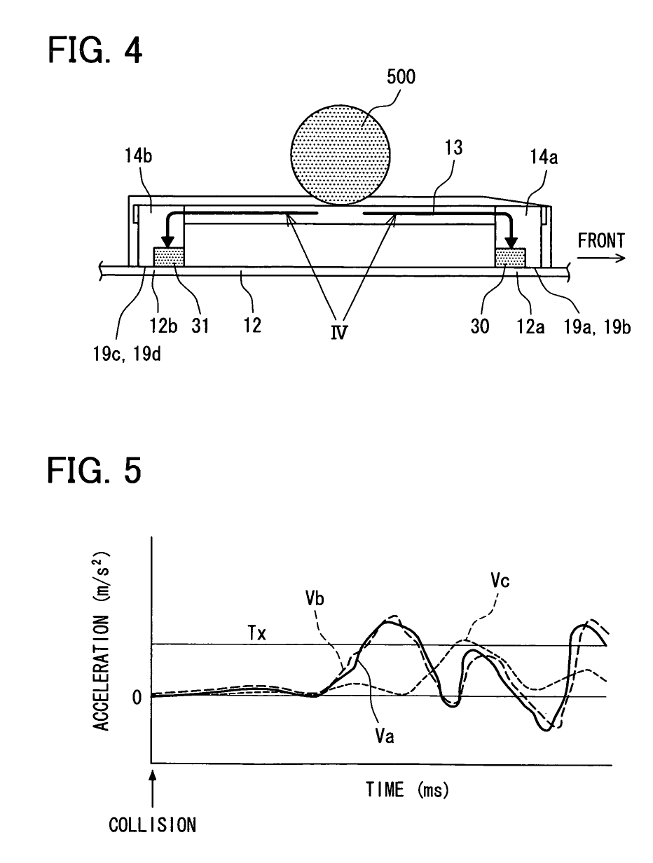

When a narrow object, for example, a telegraph pole 500 collides with the side door 1 at a center portion of the reinforcing member 13, as illustrated in FIG. 4, impact acceleration is transmitted from the reinforcing member 13 to the acceleration sensors 30 and 31 though corresponding attaching parts 14a and 14b and corresponding end portions 12a and 12b, as shown by arrows IV. Thus, the impact acceleration passes trough only components each having the high flexural rigidity. In addition, the acceleration pathway is shorter than a case where an acceleration sensor is disposed at a center pillar or the center portion 12c of the inner panel 12. Thus, the acceleration sensors 30 and 31 can detect the impact acceleration early with a high degree of certainty and can output signals in accordance with the detected acceleration to an external device, for example, a control device of an airbag.

Each of the end portions 12a and 12b of the inner panel 12 has the high flexural rigidity. In addition, a distance from each of the attached portions 19a and 19b to the front acceleration sensor 30 and a distance from each of the attached portions 19c and 19d to the rear acceleration sensor 31 are short. Thus, the impact acceleration is only slightly reduced between each of the attached portions 19a and 19b to the front acceleration sensor 30 and between each of the attached portions 19c and 19d to the rear acceleration sensor 31.

An arrangement of the acceleration sensors 30 and 31 in the side door 1 according to the present embodiment and an arrangement of an acceleration sensor 40 in a side door 400 according to an example of the related art will now be compared. The acceleration sensors 30, 31, and 40 have similar properties. The front acceleration sensor 30 is disposed at the front end portion 12a of the inner panel 12 and the rear acceleration sensor 31 is disposed at the rear end portion 12b of the inner panel 12, as illustrated in FIG. 4. The acceleration sensor 40 is disposed at a center portion of the inner panel 401 in a front-rear direction of a vehicle. In FIG. 5, a relationship between a detecting time and a detected acceleration of the front acceleration sensor 30 is shown by solid line Va, a relationship between a detecting time and a detected acceleration of the rear acceleration sensor 31 is shown by bold dashed line Vb, and a relationship between a detecting time and a detected acceleration of the acceleration sensor 40 is shown by dashed line Vc. The detected acceleration of each of the acceleration sensors 30 and 31 becomes greater than the detected acceleration of the acceleration sensor 40. In addition, a time from a collision until the detected acceleration of each of the acceleration sensors 30 and 31 exceeds a threshold value Tx is shorter than a time from the collision until the detected acceleration of the acceleration sensor 40 exceeds the threshold value Tx. Thus, the airbag can be deployed early with a high degree of certainty by using the acceleration sensors 30 and 31.

When a wide object, for example, another vehicle collides with the side door 1, the whole area of the side door 1 receives impact. Thus, the acceleration sensors 30 and 31 disposed at corresponding end portions 12a and 12b of the inner panel 12 can directly receive the impact acceleration. Therefore, the acceleration sensors 30 and 31 can detect the impact acceleration early.

As described above, the acceleration sensors 30 and 31 disposed at corresponding end portions 12a and 12b of the inner panel 12 detect the impact acceleration applied to the reinforcing member 13. Thus, when a light collision that only dents the outer panel 11 and hardly affects the reinforcing member 13 occurs, the acceleration sensors 30 and 31 do not transmit signals greater than the threshold value Tx. Therefore, in the present case, the airbag is restricted from deploying.

In an example illustrated in FIG. 3A, the front acceleration sensor 30 is disposed between the upper attached portion 19a and the lower attached portion 19b of the front end portion 12a and the rear acceleration sensor 31 is disposed between the upper attached portion 19c and the lower attached portion 19d of the rear end portion 12b. Alternatively, the front acceleration sensor 30 may be disposed at one of the attached portions 19a and 19b and the rear acceleration sensor 31 may be disposed at one of the attached portions 19c and 19d.

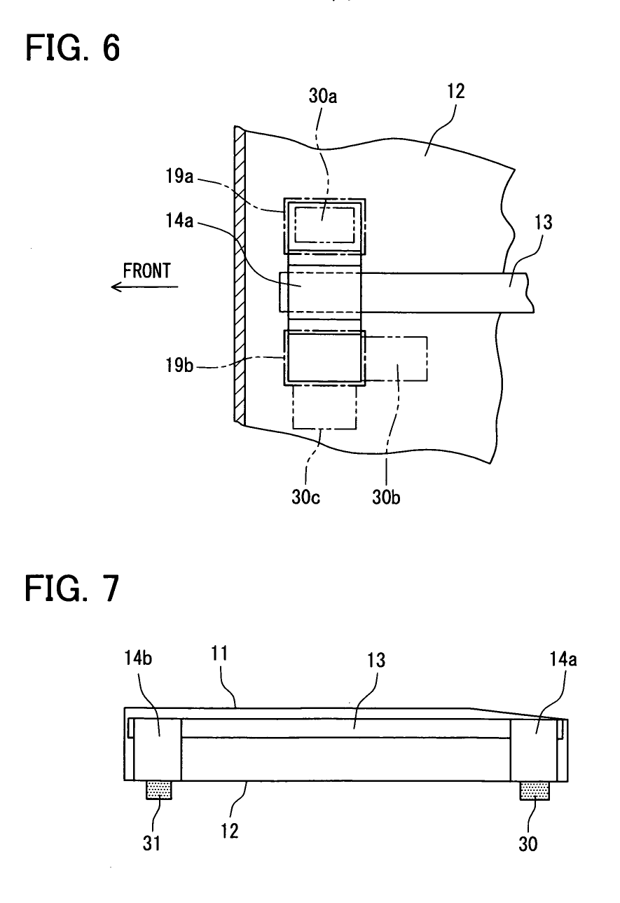

For example, the front acceleration sensor 30 may be disposed at the upper attached portion 19a of the front end portion 12a on the outer panel 11 side, as shown by dashed-two dotted line 30a in FIG. 6. In the present case, the front acceleration sensor 30 is attached to the upper flange 16a of the front attaching part 14a. The front acceleration sensor 30 is located within the upper attached portion 19a. That is, the front acceleration sensor 30 overlaps the upper attached portion 19a in the upper-lower direction and in the front-rear direction of the vehicle.

The front acceleration sensor 30 may also be disposed at a portion being in contact with the lower attached portion 19b in the front-rear direction, as shown by dashed-two dotted line 30b in FIG. 6. In the present case, the front acceleration sensor 30 may be attached on the surface of the inner panel 12 on the outer panel 11 side. The acceleration sensor 30 is in contact with the lower attached portion 19b in the front-rear direction and overlaps the lower attached portion 19b in the upper-lower direction.

The front acceleration sensor 30 may also be disposed at a portion being in contact with the lower attached portion 19b in the upper-lower direction, as shown by dashed-two dotted line 30c in FIG. 6. In the present case, the front acceleration sensor 30 is attached on the surface of the inner panel 12 on the outer panel 11 side. The front acceleration sensor 30 is in contact with the lower attached portion 19b in the upper-lower direction and overlaps the lower attached portion 19b in the front-rear direction.

When the front acceleration sensor 30 is disposed at one of the portions shown by dashed-two dotted lines 30a, 30b, 30c, the front acceleration sensor 30 is located at substantially the same height with one of the attached portions 19a and 19b and is located at substantially the same position with the one of the attached portions 19a and 19b in the front-rear direction.

In the present cases, the acceleration pathway is reduced compared with a case where the front acceleration sensor 30 is disposed between the upper attached portion 19a and the lower attached portion 19b as illustrated in FIG. 3A. Thus, an adversely effect due to a portion between the front acceleration sensor 30 and the attached portions 19a and 19b is further reduced. As a result, the airbag can be deployed earlier.

In the side door 1 illustrated in FIG. 2, the acceleration sensors 30 and 31 are disposed at corresponding end portions 12a and 12b of the inner panel 12 on the outer panel 11 side. In the present case, the surface of the inner panel 12 on the inside of the vehicle can be approximately flat. Thus, a resin cover attached to the surface of the inner panel 12 on the inside of the vehicle can be formed easily. Alternatively, the acceleration sensors 30 and 31 may also be disposed at corresponding end portions 12a and 12b on the inside of the vehicle, as illustrated in FIG. 7. In the present case, an attachment and a replacement of the acceleration sensors 30 and 31 can be performed easily.

### Second Embodiment

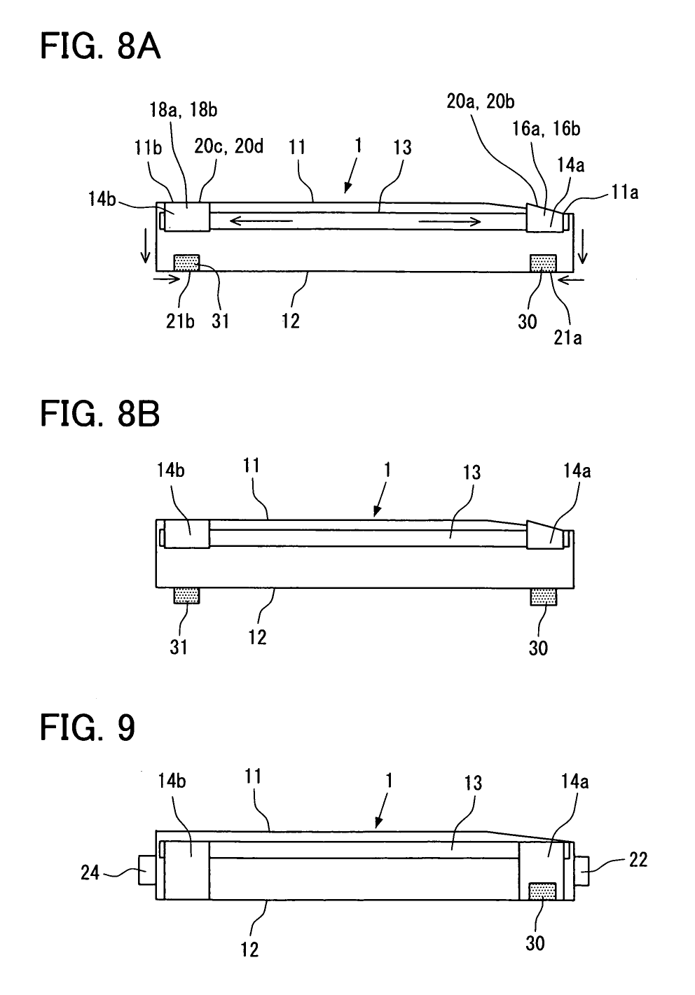

A side door 1 according to a second embodiment will be described with reference to FIG. 8A. In the present embodiment, the reinforcing member 13 is attached to the outer panel 11. The front end portion 11a of the outer panel 11 has an upper attached portion 20a and a lower attached portion 20b. The rear end portion 11b of the outer panel 11 has an upper attached portion 20c and a lower attached portion 20d. The upper flange 16a of the front attaching part 14a is fixed to the upper attached portion 20a and the lower flange 16b of the front attaching part 14a is fixed to the lower attached portion 20b. The upper flange 18a of the rear attaching part 14b is fixed to the upper attached portion 20c and the lower flange 18b of the rear attaching part 14b is fixed to the lower attached portion 20d. Thus, the reinforcing member 13 is attached to the side door 1 through the attaching parts 14a and 14b.

The inner panel 12 has a front sensor attached portion 21a and a rear sensor attached portion 21b on the outer panel 11 side. The front acceleration sensor 30 is disposed at the front sensor attached portion 21a and the rear acceleration sensor 31 is disposed at the rear sensor attached portion 21b. For example, the front sensor attached portion 21a is opposite to the upper attached portion 20a of the front end portion 11a. The rear sensor attached portion 21b is opposite to the upper attached portion 20c of the rear end portion 11b of the outer panel 11. The front sensor attached portion 21a is located at the front end portion 12a of the inner panel 12. The rear sensor attached portion 21b is located at the rear end portion 12b of the inner panel 12.

When an object collides with the side door 1, an impact acceleration applied to the reinforcing member 13 is transmitted to the acceleration sensors 30 and 31 through corresponding attaching parts 14a and 14b and corresponding end portions 11a and 11b, as shown by arrows illustrated in FIG. 8. For example, the impact acceleration is transmitted from the upper attached portion 20a and the lower attached portion 20b of the front end portion 11a to the front sensor attached portion 21a through the U-shaped end portion and reaches the front acceleration sensor 30. Thus, the impact acceleration passes through only components each having the high flexural rigidity and reaches the acceleration sensors 30 and 31 by the shortest way. Therefore, the airbag can be deployed early with a high degree of certainty.

The acceleration sensors 30 and 31 may be disposed at corresponding end portions 12a and 12b on the inside of the vehicle, as illustrated in FIG. 8B. Also in the present case, effects similar to the above-described effects of the side door 1 illustrated in FIG. 8A can be obtained.

### Third Embodiment

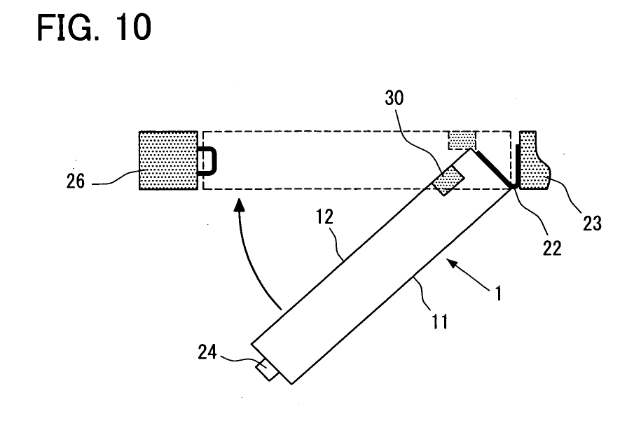

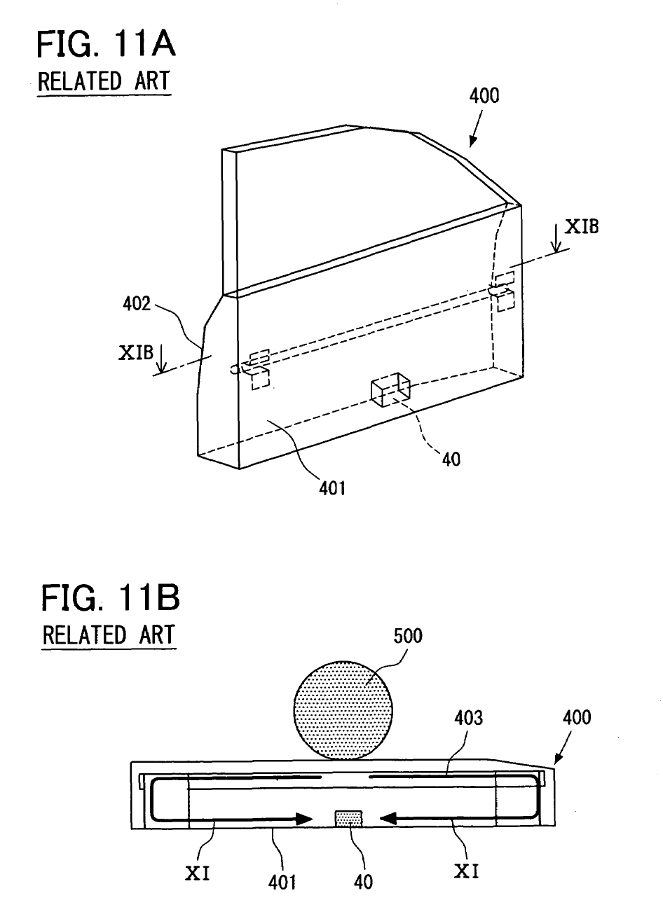

A side door 1 according to a third embodiment will be described with reference to FIG. 9 and FIG. 10. The side door 1 has a hinge 22 on the front side for rotatably holding the side door 1 with respect to a front pillar (A-pillar) 23. In addition, the side door 1 has a striker 24 on the rear side for locking the side door 1 to a center pillar (B-pillar) 26.

The side door 1 according to the present embodiment includes the front acceleration sensor 30 disposed at the front end portion 12a. The reinforcing member 13 is attached to the inner panel 12 through the attaching parts 14a and 14b in a manner similar to the side door 1 illustrated in FIG. 2.

When an acceleration sensor is arranged on the striker 24 side and the side door 1 is closed strongly, the acceleration sensor detects impact acceleration due to closing the side door 1. Then, the control device of the airbag may determine that the impact acceleration output from the acceleration sensor is impact acceleration due to a collision by error. The side door 1 according to the present embodiment includes only the front acceleration sensor 30 disposed on the front side. Thus, even if the side door 1 is closed strongly, an impact acceleration detected by the front acceleration sensor 30 is less than impact acceleration due to a collision. Therefore, an erroneous determination due to closing the side door 1 strongly is restricted. In addition, effects similar to the above-described embodiments can be obtained. In the side door 1 illustrated in FIG. 9, the front acceleration sensor 30 is disposed on the surface of the inner panel 12 on the outer panel 11 side. The front acceleration sensor 30 may also be disposed on the surface of the inner panel 12 on the inside of the vehicle. The attaching parts 14a and 14b may also be attached to the outer panel 11.

In a case where an acceleration sensor is also arranged on the rear side, that is, on the striker 24 side, the front acceleration sensor 30 arranged on the hinge 22 side may be used as a main sensor and the acceleration sensor arranged on the striker 24 side may be used as a safety sensor. In the present case, an erroneous determination due to closing the side door 1 strongly is effectively restricted.

The side door 1 illustrated in FIG. 9 is a front door. In a case where the side door 1 is a rear door, the front acceleration sensor 30 may be disposed on the center pillar 26 side.

Although the present invention has been fully described in connection with the preferred embodiments thereof with reference to the accompanying drawings, it is to be noted that various changes and modifications will become apparent to those skilled in the art.

What is claimed is:

1. A side door of a vehicle comprising:
an outer panel having a front end portion, a center portion, and a rear end portion in a front-rear direction of the vehicle;
an inner panel located opposite to the outer panel and having a front end portion, a center portion, and a rear end portion in the front-rear direction;
a reinforcing member located between the outer panel and the inner panel;
a front attaching part and a rear attaching part coupled with the reinforcing member, the front attaching part fixed to a front attached portion provided at one of the front end portion of the outer panel and the front end portion of the inner panel, the rear attaching part fixed to a rear attached portion provided at one of the rear end portion of the outer panel and the rear end portion of the inner panel; and
an acceleration sensor disposed at one of the front end portion of the outer panel, the front end portion of the inner panel, the rear end portion of the outer panel, and the rear end portion of the inner panel, for detecting an impact acceleration applied to the reinforcing member when an object collides with the side door, wherein:
a flexural rigidity of the front end portion of the outer panel and a flexural rigidity of the rear end portion of the outer panel are greater than a flexural rigidity of the center portion of the outer panel;
a flexural rigidity of the front end portion of the inner panel and a flexural rigidity of the rear end portion of the inner panel are greater than a flexural rigidity of the center portion of the inner panel; and
a flexural rigidity of the reinforcing member, a flexural rigidity of the front attaching part, and a flexural rigidity of the rear attaching part are greater than the flexural rigidity of the center portion of the outer panel.

2. The side door according to claim 1, wherein
the flexural rigidity of the front attaching part and the flexural rigidity of the rear attaching part are substantially equal to the flexural rigidity of the reinforcing member.

3. The side door according to claim 1, wherein
the front attached portion and the rear attached portion are located at a first height in an upper-lower direction of the vehicle;
the acceleration sensor is located at a second height in the upper-lower direction; and
the second height is substantially equal to the first height.

4. The side door according to claim 1, further comprising
a hinge for rotatably holding the outer panel and the inner panel with respect to the vehicle, the hinge located adjacent to the one of the end portions where the acceleration sensor is disposed.

5. The side door according to claim 1, wherein:
the front attached portion is provided at the front end portion of the inner panel;
the rear attached portion is provided at the rear end portion of the inner panel; and
the acceleration sensor is disposed on a surface of the inner panel on the outer panel side and is located at one of the front attached portion and the rear attached portion.

6. The side door according to claim 1, wherein:
the front attached portion is provided at the front end portion of the inner panel;
the rear attached portion is provided at the rear end portion of the inner panel; and
the acceleration sensor is disposed on a surface of the inner panel on an inside of the vehicle and is located at one of the front attached portion and the rear attached portion.

7. The side door according to claim 1, wherein:
the front attached portion is provided at the front end portion of the outer panel;
the rear attached portion is provided at the rear end portion of the outer panel; and
the acceleration sensor is disposed on a surface of the inner panel on the outer panel side and is located at a portion of the inner panel opposite to one of the front attached portion and the rear attached portion.

8. The side door according to claim 1, wherein:
the front attached portion is provided at the front end portion of the outer panel;
the rear attached portion is provided at the rear end portion of the outer panel; and
the acceleration sensor is disposed on a surface of the inner panel on an inside of the vehicle and is located at a portion of the inner panel opposite to one of front attached portion and the rear attached portion.

9. The side door according to claim 1, wherein
the acceleration sensor is in contact with one of the front attaching part and the rear attaching part.
